(19) United States
(12) Patent Application Publication
(10) Pub. No.: US 2013/0180995 A1
(43) Pub. Date: Jul. 18, 2013

(54) Gas Cylinder with Measuring Connection

(71) Applicants: Peter Koll, Aschau (DE); Mirko Di Marco, Kleinwallstadt (DE)

(72) Inventors: Peter Koll, Aschau (DE); Mirko Di Marco, Kleinwallstadt (DE)

(73) Assignee: WIKA Alexander Wiegand SE & CO. KG, Klingenberg (DE)

(21) Appl. No.: 13/517,142

(22) PCT Filed: Dec. 21, 2009
(86) PCT No.: PCT/EP2009/067683

§ 371 Date: Aug. 6, 2012

(51) Int. Cl. F17C 13/02

(52) U.S. Cl. CPC F17C 13/02
USPC 220/581; 220/694

(57) ABSTRACT

A gas cylinder has a circular-cylindrical shell which is closed on one end by a bung assembly having a connection hole extending along a longitudinal axis direction of the cylinder. The bung assembly has an auxiliary hole extending in a direction which is inclined with regard to a longitudinal axis direction of the cylinder. The connection hole is for introducing gas into and retrieving gas from said gas cylinder, while the auxiliary hole cooperates with a sensor device for measuring a parameter indicative of the filling level of the gas in the cylinder. The auxiliary hole extends in a direction intersecting the central longitudinal axis direction of the gas cylinder and may have an inclination such that the auxiliary hole extends in a direction perpendicular to the central longitudinal axis direction of the gas cylinder. The auxiliary hole may be a through hole or a blind hole.

The invention relates to gas cylinder in which compressed gases are stored. The gases may be permanent gases which are stored in gaseous form only and the gases can be gases which can be liquefied and which are stored in the liquid state. The gases may be pure gases of a single type and the gases can be mixtures of gases.

Gases are used in a vast number of situations and applications in modern life. Gases are usually produced at places different form their places of use, so that transport is required. In order to store and transport reasonable amounts of gas, gases are stored in a pressurized state in gas cylinders which are known for decades for that purpose. According to the gas type, the storage pressure, or other requirements, suitable materials for the gas cylinders are selected from steel, aluminum and aluminum alloys, carbon fiber composite, glass fiber composite, alloys of non-ferrous metals, reinforced plastics and plastics, or the cylinders are made from combinations of these materials. These materials are nontransparent, so that the filling level of the gas cylinder (e.g. a liquid level) cannot be visually observed. If permanent gases or gases in gaseous form are stored, there is no liquid level in the gas cylinder, although there is a stored amount of gas in the gas cylinder. It is noted that in this application, the term filling level expresses the amount of stored gas be it stored in liquefied, partly liquefied or gaseous state in the gas cylinder.

It is of high interest to detect the filling level of a gas cylinder in order to be aware of the available gas reserve, selection of cylinders to be filled etc. Several different methods are known for detecting the filling level, wherein most of these methods use sensing devices provided at or after a shut-off valve or main valve of the gas cylinder. Therefore, a filling level detection is only available when the gas cylinder is connected to the subsequent connectors and piping and the main valve is open.

Other methods are known which estimate a fluid level in the gas cylinder indirectly through the cylinder shell, however these methods only work for liquefied gases and the precision of the measurement is not very high. Also, the mass of a gas contained in a gas cylinder is usually small as compared to the mass of the cylinder itself, so that weighing of the cylinder fails to provide precise estimate of the filling level of the cylinder.

It is an object of the invention to provide a gas cylinder which allows a simple and precise detection of the filling level, even if the gas cylinder is in a disconnected state or separated state.

This object is solved with a gas cylinder having the features of claim 1. Advantageous modifications are depicted in the dependent claims.

The invention provides a gas cylinder which has a circular-cylindrical shell which is closed on one end by a bung assembly having a connection hole extending along a longitudinal axis direction of the cylinder. The other end of the gas cylinder is closed in a manner well known in the art; usually a cup shaped end cap or calotte which can be formed uniform with the shell material. The bung assembly has an auxiliary hole extending in a direction which is inclined with regard to a longitudinal axis direction of the cylinder.

The connection hole is for introducing gas into and retrieving gas from said gas cylinder, and can be provided with a shut-off valve or main valve. For this, the connection hole is suitably designed, e.g. having a tapered thread or thread and sealing surface combinations. The connection hole can be a center hole extending in the central longitudinal axis direction of the gas cylinder.

The auxiliary hole is adapted to communicate with a sensor device for measuring a parameter indicative of the filling level of the gas in the cylinder. By providing an inclined auxiliary hole in the bung assembly, it is possible to place a sensor, sensor means or a sensing device or the like in the hole so as to communicate with the inside of the gas cylinder. The auxiliary hole may extend in a direction intersecting the central longitudinal axis direction of the gas cylinder. Furthermore, the auxiliary hole may extend at a rectangular inclination, i.e. in a direction perpendicular to the central longitudinal axis direction of the gas cylinder.

The arrangement of the auxiliary hole so as to extend in an inclined direction allows that sensors or the like mounted to the auxiliary hole do not protrude into the area or region in which the connection parts to be connected to the main valve of the gas cylinder are accommodated. If the main valve is a valve screwed into the connection hole, it may happen that the connection parts of that valve overlap the position of the auxiliary hole. By the inclined arrangement, there is sufficient room above a sensor means mounted to the auxiliary hole, so that this problem is solved. Further, by using the inclined arrangement, the sensor means do not protrude into the area or region in which the tools (usually wrenches etc.) are moved when the gas cylinder is connected/disconnected. This avoids inadvertent damage of the sensor means. A compact arrangement is obtained for the sensors means when the auxiliary hole extends in a direction perpendicular to the cylinder axis. Due to this compact arrangement, stacking height of plural gas cylinders is reduced, so that transport space and storage space can be saved.

Depending on the measurement principle used for determining the filling level, the auxiliary hole may be a through hole communicating with the inside volume of the gas cylinder. In this case, it is possible to use a pressure sensor screwed into the auxiliary hole, detecting the cylinder pressure in direct contact with the gas. If a combined pressure and temperature sensor is used and placed in direct contact with the gas to be measured, filling level estimations offering sufficiently precise results can be made using maps or the like. A sensing device can be provided which can be designed to use stored maps to automatically determine and display the measured filling level.

In the above arrangement, the auxiliary hole has sealing means cooperating with the sensor of the sensor device, wherein the sensor and the sealing device hermetically seal said auxiliary hole, so that the sensor is exposed to the gas to be measured.

In an alternative arrangement the auxiliary hole may have sealing means which cooperating with a partition wall member which hermetically seals the auxiliary hole. In that case, the partition wall member can be permeable to measuring signals transmitted from inside the gas cylinder to the outside thereof and to the sensing device.

As for the sealing means several arrangements known in the art may be used, in particular it may be a tapered thread in the auxiliary hole, a thread and a sealing surface in the auxiliary hole, an annular sealing surface extending around the axial end of the auxiliary hole, and a sealing surface in combination with a fixing means provided on the bung assembly. Alternatively or additionally, the sealing means comprise a connection which is made by using at least one of a gluing, brazing and welding.

As an alternative, the auxiliary hole can be made as a blind hole, and the material of the bung assembly, at least at a portion corresponding to the auxiliary hole, is permeable to measuring signals transmitted from inside the gas cylinder to the outside thereof and to the sensing device. A suitable material for this is e.g. brass. The cylinder shell is typically made from heat conducting materials such as metal so that a temperature may be fixed in heat conducting contact to the cylinder shell for temperature measurement. Even if other materials are used, and quick temperature changes of the gas have not to be expected when gas is retrieved from the gas cylinder, this arrangement of the temperature sensor on the shell can be sufficient and may be used.

As mentioned above, the sensing device may be adapted to measure a gas pressure and/or a gas temperature of the gas in the gas cylinder. On the other hand the sensing device can be in the form of a liquid level measuring device using a float, wherein the floating position of the float is detected and is transmitted to the sensing device. In particular, there can be used a float which operates a link mechanism which moves a magnet according to float position. The change of the magnetic field may be sensed through the partition wall element or through the remainder of bung wall it the bottom of the blind auxiliary hole, so as to be a parameter indicative of the filling level which is then interpreted to determine the filling level. This determination may also be conducted automatically.

As mentioned above with reference to the background of the invention the gas cylinder shell and/or the bung assembly may be made for a material selected from a group comprising: steel, aluminum and aluminum alloys, carbon fiber composite, glass fiber composite, alloys of non-ferrous metals, reinforced plastics and plastics, or from a combination of at least two of these materials.

In an advantageous modification, the sensor (means) may permanently stay fixed to the gas cylinder and is well protected during transport and operation of the gas cylinder. Furthermore, the sensing device using the sensed parameter(s) may be provided on said gas cylinder shell, wherein the sensing device preferably has a display means for displaying the determined filling level.

If an electrically operated sensor/sensor means and sensing device is used, a rechargeable or ordinary battery may be used for power supply. The display may preferably show the filling level so that this information is available during use and transport. A button triggering a temporary display of the data saves battery power.

The sensing means may be fixed adapted to a single type of gas or may be programmable. Also, the sensing device may be supplied as plug-on device, which can be plugged to the individual gas cylinder to be monitored.

Further features and advantageous modifications of the invention may be gathered from the below description of preferred embodiments of the invention which are described hereafter by reference being made to the drawing figures.

The drawing shows in:

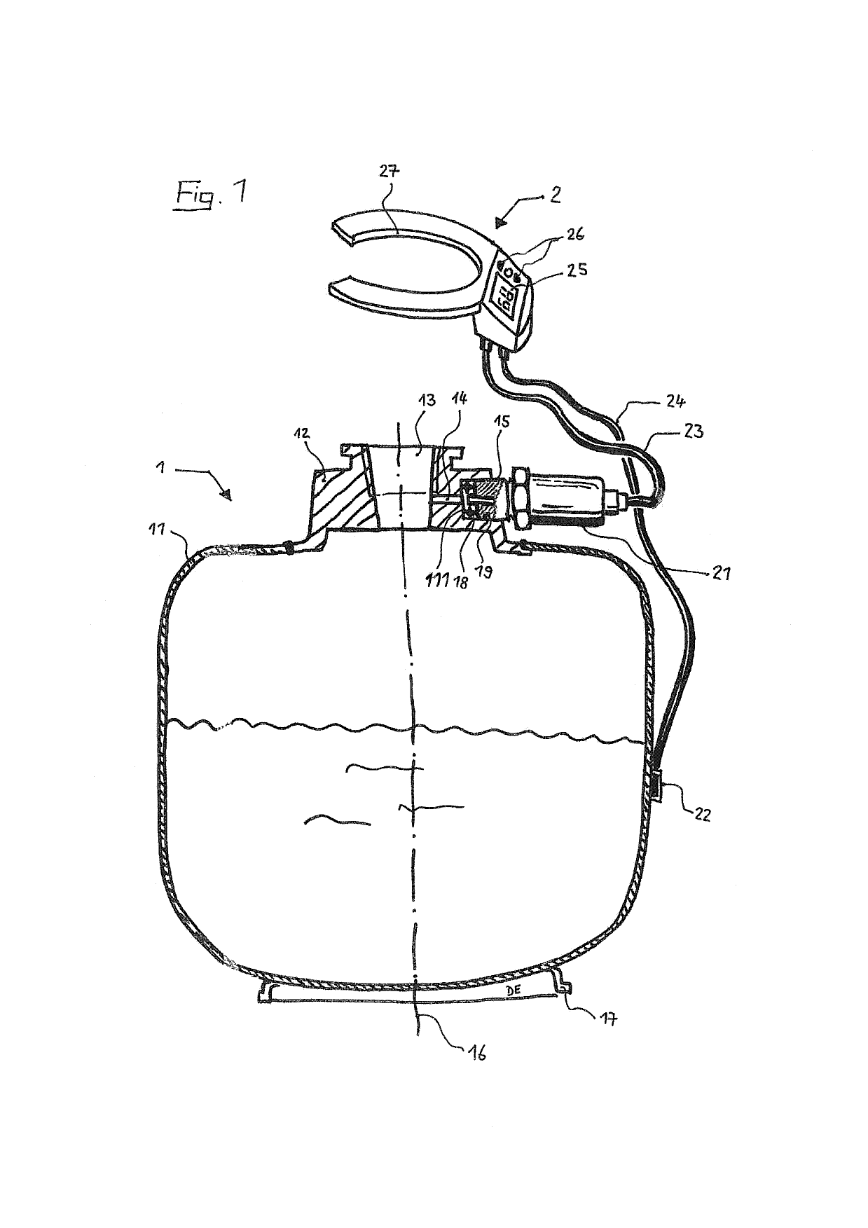

FIG. 1 a first embodiment of a gas cylinder according to the invention which carries a pressure sensor and a temperature sensor, and for which a snap-on sensing device fixable to the cylinder is provided;

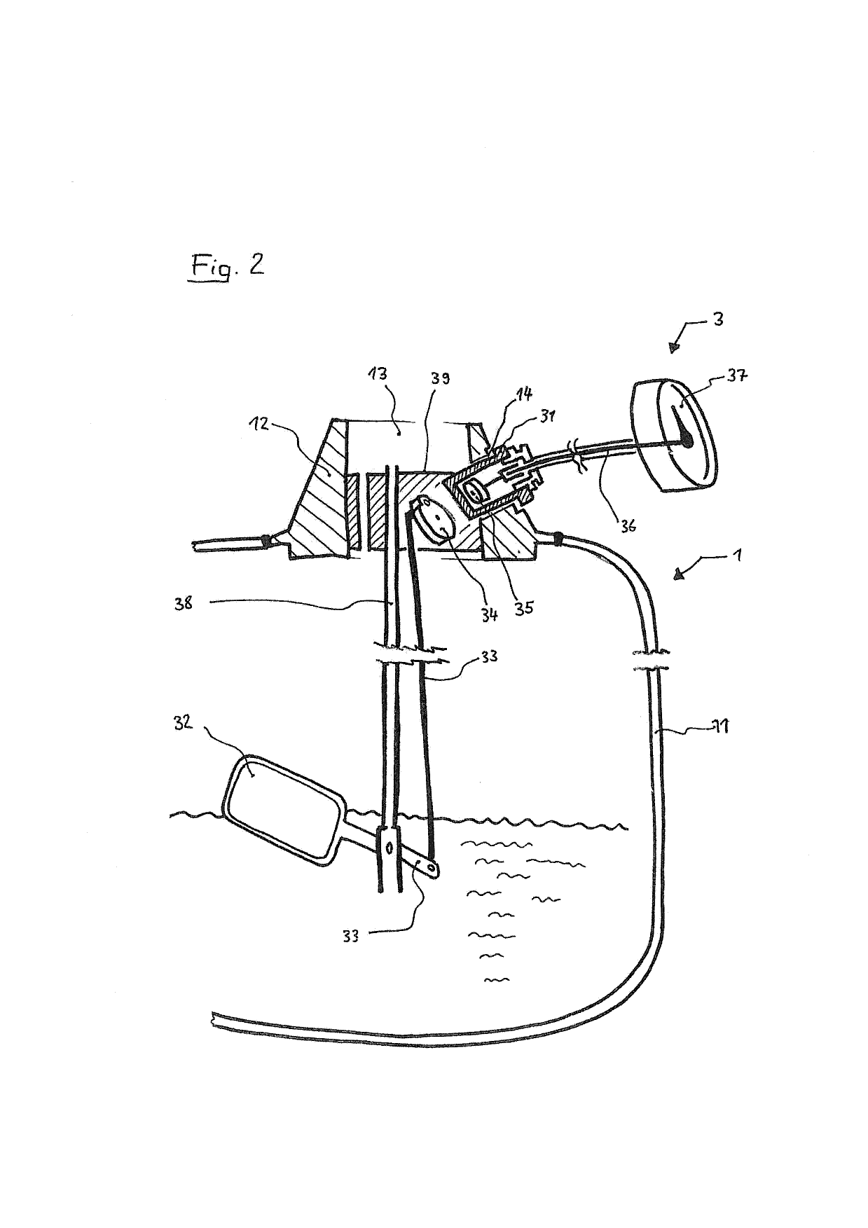

FIG. 2 a second embodiment in which a float is used for detecting a liquid gas level as the filling level; and

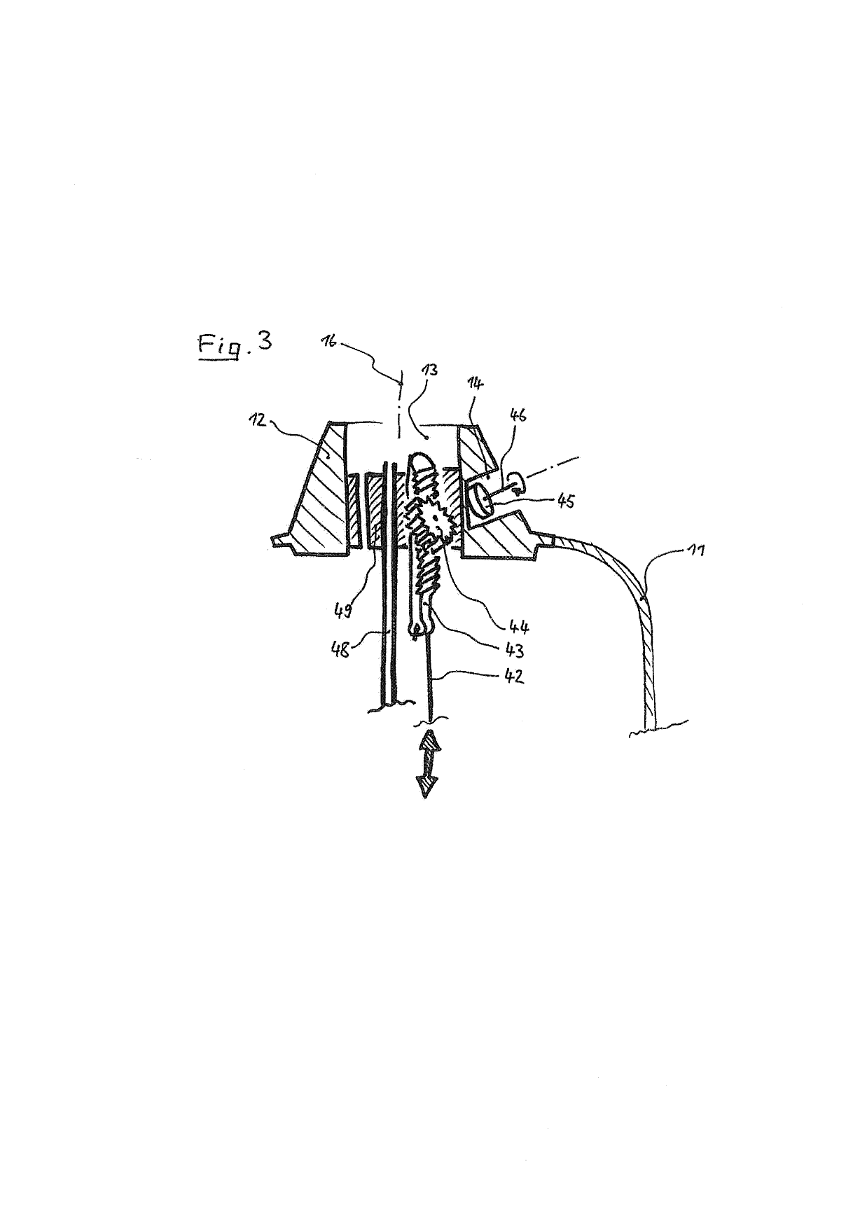

FIG. 3 a modified form of the auxiliary hole used in FIG. 2.

FIG. 1 shows a gas cylinder 1 having a cylinder shell 11 and a bung assembly 12 fixed to the cylinder shell 11 by welding or the like. The gas cylinder 11 has a circular cylindrical shape with a central longitudinal axis 16 (or rotational axis) and further has a foot portion 17 for standing upright. The gas cylinder 1 is closed at his lower end by a calotte in the usual manner, which calotte may be provided separately or may be formed in uniform with the cylinder shell 11.

The bung assembly 12 has a connection hole 13 extending in the direction of the central longitudinal axis 16. This connection hole 13 is provided with means to hermetically receive a valve (not shown) which valve is used to interrupt the connection of the cylinder inside to the outside, i.e. it is a shut-off valve or main valve. This valve may be of commonly known construction, so that any further description is omitted.

The bung assembly 12 further has an auxiliary hole 14 extending from the side into the connection hole 13. Here, the inclination of the auxiliary hole 14, that is the inclination of the axis or extension direction of the hole, is approx 90° with respect to the central longitudinal axis 16 of the gas cylinder 1. Apart from this perpendicular constellation, other inclination may be selected at need. For example, a slightly downward inclination of the auxiliary 14 improve removal of liquid (gas) which may have collected in the auxiliary hole when handling the cylinder. In this case, a trade-off between compact packaging the sensor to the cylinder and liquid removal leads to an appropriate inclination angle.

The auxiliary hole 14 has the form of a stepped bore which—in this order form inside the cylinder to the outside—has a communication hole, a sealing surface 18 and an internal thread portion 15. The diameters of the auxiliary hole 14 increase in the order mentioned.

As is further shown in FIG. 1, a pressure sensor 21 is screwed into the auxiliary hole 14, and a temperature sensor 22 is fixed to the cylinder shell 11 from the outside by means of a heat conducting connection. The pressure sensor 21 and the temperature sensor 22 are connected to a sensing device 2 by means of wiring 23 and 24.

The pressure sensor 21 is screwed into the thread portion 15 of the auxiliary hole 14 whereby a sealing ring 111 which may be an O-ring or a metal sealing ring, provided on the pressure sensor 21 is set in opposing relationship to the sealing surface 18 of the auxiliary hole 14. The diameter of the sealing surface 18 is set such that the sealing ring 111 is compressed to provide a tight and durable seal, hermetically sealing the auxiliary hole 14, since the pressure sensor 21 is a hermetically sealed element. When making the diameter of the sealing surface 18 smaller than the diameter of the thread portion 15, the sealing ring 111 is not damaged when mounting the pressure sensor 21. It is noted that the sealing ring can be made of soft metal (such as copper or the like) or may be made from ceramics, elastomers, PTFE or other suitable materials. In this case, the shape of the sealing surface 18 is suitably adapted.

Reference sign 19 indicates a built-in temperature sensor provided in the pressure sensor 21. Depending on the measurement principle and design of the pressure sensor 21, the built-in temperature sensor 19 can be located sideways in the sensor's body in a manner shown in FIG. 1, however, integration of a temperature sensor in a pressure sensing diaphragm of the pressure sensor is also an available option.

The sensing device 2 has a display 25 and control elements (buttons) 26 for controlling the operation of sensing device. The sensing device 2 contains electronic circuits, a memory, a power supply (battery) and the like elements, which are typically provided in a device which interprets an analog or digital measurement value to provide the required information.

The sensing device 2 has a horseshoe-shaped collar 27 which forms a snap-on holder for the sensing device 2 on the gas cylinder 1. The shape of the sensing device 2 is advantageously set such that it smoothly fits to the shape of the gas cylinder, so as to not expose edges at which the sensing device 2 may get caught to be torn off the gas cylinder 1. In the arrangement in FIG. 1 the sensing device is designed to be permanently fixed mounted to the gas cylinder 1. Therefore, the snap-on collar may be of a design that it breaks when removed from the cylinder, so that no unauthorized exchange/replacement of a sensing device is possible without being clearly noticeable.

FIG. 2 shows another embodiment using a different measurement principle. All elements having the same reference sign as in FIG. 1 have the same function as is described there, so that a repetition of this description is omitted here. Thus only the differences will be described hereinafter.

A plug 39 in the connection hole 13 carries a support 38 on which a link system 33 is supported. The link system 33 is connected to a float 32 designed to float on liquefied gas. The movement of the float 32 is transferred by link system 33 to a magnet disc 34, which rotates in synchronism with the movements of the float 32.

In the auxiliary hole 14, there is inserted a partition wall member 31 in which a receiver magnet 35 is rotatably supported. A shaft 36 transmits rotational movement of the receiver magnet 35 to a pointer of a display device 3.

The partition well member 31 is made from a non-magnetic material like brass or plastics and is held and hermetically sealed in the auxiliary hole 14 by welding brazing or gluing. Alternatively, the partition wall member may be screwed into the auxiliary hole, for which a design of sealing surfaces and threads similar to that of FIG. 1 may be adopted.

It is noted that in the solution of FIG. 2, the auxiliary hole may also extend perpendicularly to the central longitudinal axis of the gas cylinder 1. It is further noted that this solution does not require an power supply and offers a permanent and precise indication of the filling level.

Finally, FIG. 3 depicts an alternative solution to the generation of the signal indicative of the position of a float (not shown) floating on liquid gas in a gas cylinder 1.

A plug 49 in the connection hole 13 carries a support 48 on which a link system 42 is supported. The link system 42 is connected to a float (not shown) designed to float on liquefied gas. The movement of the float is transferred by link system 42 to a converter 43 in the form of a rack which rotates a magnet gear 44 in synchronism with the movements of the float. In the auxiliary hole 14, which is a blind hole, a receiver magnet 45 is rotatably supported. A shaft 46 transmits rotational movement of the receiver magnet 45 to a display device (not shown). The bung assembly 12 is made of a non-magnetic material which allows transmission of magnetic forces. These materials can be for example brass or plastics.

The invention has been described in several general applications as well as by way of particular embodiments. The invention resides in combinations of features which may be separately collected from the above embodiments, e.g. the inclination of the auxiliary hole. Further construction elements described may be replaced by suitable constructions known in the art, in particular the connection of the bung assembly to the cylinder shell can be carried out in any manner known to those skilled in the art.

Apart from the solutions described in detail in the embodiments, other sensor types may be used which include humidity sensor, optical sensors, float sensors, strain sensors, hall sensors, acoustic sensors or other sensing means which are suitable to directly or indirectly measure a parameter which is indicative of the filling level.

1. A gas cylinder having a circular-cylindrical shell which is closed on one end by a bung assembly having a connection hole extending along a longitudinal axis direction of the cylinder, and having an auxiliary hole extending in a direction which is inclined with regard to a longitudinal axis direction of the cylinder, wherein
said connection hole is for introducing gas into and retrieving gas from said gas cylinder, and
said auxiliary hole cooperates with a sensor device for measuring a parameter indicative of the filling level of the gas in the cylinder.

2. A gas cylinder according to claim 1, wherein said connection hole is a center hole extending in the central longitudinal axis direction of the gas cylinder.

3. A gas cylinder according to claim 1, wherein the auxiliary hole extends in a direction intersecting the central longitudinal axis direction of the gas cylinder.

4. A gas cylinder according to claim 1, wherein the auxiliary hole extends in a direction perpendicular to the central longitudinal axis direction of the gas cylinder.

5. A gas cylinder according to claim 1, wherein the auxiliary hole is a through hole communicating with the inside volume of the gas cylinder.

6. A gas cylinder according to claim 5, wherein the auxiliary hole has sealing means cooperating with a sensor of the sensor device, wherein said sensor and said sealing device hermetically seal said auxiliary hole, said sensor being exposed to the gas to be measured.

7. A gas cylinder according to claim 5, wherein the auxiliary hole has sealing means cooperating with a partition wall member hermetically sealing said auxiliary hole, said partition wall member being permeable to measuring signals transmitted from inside the gas cylinder to the outside thereof and to said sensing device.

8. A gas cylinder according to claim 6, wherein the sealing means comprises at least one of a tapered thread in the auxiliary hole, a thread and a sealing surface in the auxiliary hole, an annular sealing surface extending around the axial end of the auxiliary hole, and a sealing surface in combination with a fixing means provided on said bung assembly.

9. A gas cylinder according to claim 6, wherein said sealing means comprises a connection using at least one of a gluing, brazing and welding.

10. A gas cylinder according to claim 1, wherein the auxiliary hole is a blind hole, and a material of said bung assembly is, at least at a portion corresponding to said auxiliary hole, permeable to measuring signals transmitted from inside the gas cylinder to the outside thereof and to said sensing device.

11. A gas cylinder according to claim 1, wherein said sensing device is adapted to measure a gas pressure inside the gas cylinder.

12. A gas cylinder according to claim 1, wherein said sensing device is adapted to measure a gas temperature inside the gas cylinder.

13. A gas cylinder according to claim 1, wherein a liquid level measuring device using a float, wherein the floating position of the float is detected and is transmitted to said sensing device.

14. A gas cylinder according to claim 1, wherein said cylinder shell and/or said bung assembly consist of a material selected from a group comprising: steel, aluminum and aluminum alloys, carbon fiber composite, glass fiber composite, alloys of non-ferrous metals, reinforced plastics and plastics, or consists of combination of at least two of these materials.

15. A gas cylinder according to claim 1, wherein said sensing device is adapted to determine said filling level from at least one of the following parameters or sets of parameters: a measured gas pressure, a measured float position, a measured gas pressure in combination with a gas temperature, a measured float position in combination with at least one of a gas pressure and a gas temperature.

16. A gas cylinder according to claim 1, wherein a pressure sensor or a combined pressure and temperature sensor is accommodated in the auxiliary hole.
